(19) United States
(12) Patent Application Publication
(10) Pub. No.: US 2024/0426853 A1
(43) Pub. Date: Dec. 26, 2024

(54) MODULAR EXPERIMENT AUTONOMATION SYSTEM AND METHOD OF OPERATING THE SAME

(71) Applicant: KOREA INSTITUTE OF SCIENCE AND TECHNOLOGY, Seoul (KR)

(72) Inventors: Sang Soo HAN, Seoul (KR); Donghun KIM, Seoul (KR); HYUK JUN YOO, Seoul (KR); NAYEON KIM, Seoul (KR); Seung Yong LEE, Seoul (KR)

(21) Appl. No.: 18/475,100

(22) Filed: Sep. 26, 2023

(30) Foreign Application Priority Data
Jun. 23, 2023 (KR) 10-2023-0081255

(51) Int. Cl. G01N 35/00; G06Q 10/0633

(52) U.S. Cl. CPC G01N 35/00732; G01N 35/00663; G01N 35/00871; G01N 35/0099; G06Q 10/0633; G01N 2035/00841; G01N 2035/00851; G01N 2035/00881

(57) ABSTRACT

Provided is a modular experiment automation system including a main computer, a material synthesis module, and a material analysis module. The main computer interacts with a material synthesis module and a material analysis module. Upon a start request, it provides synthesis instructions for a target material. Once synthesis is complete, it instructs the analysis module to analyze the material. Based on the analysis results, if the error exceeds a threshold, it generates a new synthesis condition and re-initiates synthesis.

### CROSS-REFERENCE TO RELATED APPLICATION

This U.S. non-provisional patent application claims priority under 35 U.S.C. § 119 of Korean Patent Application No. 10-2023-0081255, filed on Jun. 23, 2023, the entire contents of which are hereby incorporated by reference.

### BACKGROUND

The present disclosure herein relates to an artificial intelligence-based unmanned modular experiment automation system and a method of operating the same.

Development of materials requires a long time until commercialization, and it is typical to develop materials through a trial-and-error experiment. Recently, researches have been carried out to improve the efficiency of simple repetitive tasks by combining robot automation technology.

However, since researchers carry out experiment processes for themselves even in this case, process data is not enough in the field of material design. Therefore, it is required to develop a system that allows researchers to continuously conduct experiments even when the researchers are temporally and spatially separated from an experiment place.

In particular, in the case of nanoparticle experiments, it is very important to secure the reliability of experimental results since such experiments are extremely sensitive. In the case of nanoparticle experiments, obtained result values are clearly different according to researcher's know-how and skill, and experimental reproducibility may vary even in experiments conducted by the same researchers.

There is an increasing demand for flexible experiment systems capable of flexibly applying orders, types, and conditions of various process methods when nanoparticle experiments are automated.

### SUMMARY

The present disclosure intends to synthesize a target material having target characteristics without human intervention using a modular experiment automation system with artificial intelligence. The present disclosure also intends to improve the reproducibility of material synthesis and the reproducibility of material analysis using the modular experiment automation system.

The purposes of the present disclosure are not limited to the above-mentioned purposes, and other purposes not mentioned would be clearly understood by those skilled in the art from the disclosure below.

An embodiment of the inventive concept provides a modular experiment automation system including: a main computer configured to receive a start request from an input device; a material synthesis module configured to synthesize a target material from a specimen; and a material analysis module configured to analyze the target material, wherein the main computer is configured to: provide the material synthesis module with a first request including a first synthesis condition for the target material on the basis of the start request; receive a first response indicating completion of a synthesis operation from the material synthesis module; provide the material analysis module with a second request indicating an analysis operation for the target material on the basis of the first response; receive a second response including an analysis value of the analysis operation from the material analysis module; determine whether the analysis value is larger than a threshold error value corresponding to a target property of the target material; generate a second synthesis condition different from the first synthesis condition on the basis of the analysis value in response to a determination that the analysis value is larger than the threshold error value; and re-perform synthesis of the target material on the basis of the second synthesis condition.

In an embodiment, the material synthesis module may include at least one of a reaction vessel storage device, a robot arm, an agitator, an XYZ linear actuator, or a specimen injection device.

In an embodiment, the reaction vessel storage device may include a first structure and a second structure, wherein the first structure and the second structure may respectively include a first space and a second space to accommodate a reaction vessel.

In an embodiment, the first structure may protrude from the second structure.

In an embodiment, the first space and a second space each may include a plurality of trenches, wherein a bottom surface of each of the trenches may have an inclined surface.

In an embodiment, the first structure and the second structure may have a friction reinforcement member arranged on the bottom surface of the trenches.

In an embodiment, the friction reinforcement member may include a stainless steel material.

In an embodiment, the first structure and the second structure each may have a rectangular first side surface and a trapezoidal second side surface and third side surface that are connected to the first side surface and have an inclined upper side, and the trench may be connected to the first to third side surfaces, wherein a height of each of the second side surface and the third side surface may increase in a direction away from the first side surface.

In an embodiment, the first structure may include a motor driven region partitioning part provided on a sidewall of the trench, wherein the motor driven region partitioning part may be arranged adjacent to the first side surface, and a distance between the first side surface and the motor driven region partitioning part may be configured to correspond to a diameter of the reaction vessel.

In an embodiment, the second structure may include a motor driven region partitioning part provided on a sidewall of the trench, wherein a distance between the first side surface and the motor driven region partitioning part may be configured to correspond to a sum of diameters of a plurality of reaction vessels.

In an embodiment, at least one of the first structure or the second structure may include a motor driven region partitioning part provided on a side surface of a trench.

In an embodiment, the reaction vessel storage device may include an Arduino board, wherein the first request may include requesting the Arduino board to perform a control operation on the motor driven region partitioning part.

In an embodiment, the specimen injection device may be coupled to the XYZ linear actuator, and the first request may include movement of the XYZ linear actuator.

In an embodiment, the specimen injection device may include a specimen storage, a syringe pump, and a specimen injection part, a specimen of the specimen storage may be moved to the specimen injection part through the syringe pump, and the specimen injection part may include a needle, a tube, and a needle-tube connection part between the needle and the tube.

In an embodiment, the modular experiment automation system may further include a coupling part between the XYZ linear actuator and the specimen injection part, wherein the coupling part may include a tube holder arranged at an upper portion and a needle arrangement hole arranged at a lower portion, and the needle arrangement hole may have a shape of a through-hole having an upper portion that is larger in diameter than a lower portion.

In an embodiment, the material analysis module may include at least one of a reaction vessel holder, a robot arm, a UV spectrometer, a measurement vessel holder, a pipette machine, or a pipette pump.

In an embodiment, the material synthesis module may further include a base plate and a fixing unit, the reaction vessel storage device, the robot arm, the agitator, the XYZ linear actuator, and the specimen injection device may be arranged on the base plate, and the fixing unit may fix the reaction vessel storage device, the robot arm, the agitator, the XYZ linear actuator, and the specimen injection device to the base plate.

In an embodiment, the base plate may be provided in plurality, and the modular experiment automation system may further include a connection part that connects adjacent base plates.

In an embodiment of the inventive concept, a method of operating a modular experiment automation system including a main computer, a material synthesis module, and a material analysis module includes: receiving, by the main computer, a start request from an external input device; providing, by the main computer, the material synthesis module with a first request including a first synthesis condition for a target material having a target property on the basis of the start request; synthesizing, by the material synthesis module, the target material on the basis of the first request and a raw material; providing, by the material synthesis module, the main computer with a first response indicating completion of a synthesis operation; providing, by the main computer, the material analysis module with a second request indicating an analysis operation for the target material on the basis of the first response; analyzing, by the material analysis module, the target material and providing the main computer with a second response including an analysis value of the analysis operation; determining, by the main computer, whether the analysis value is larger than a threshold error value corresponding to the target property of the target material; generating, by the main computer, a second synthesis condition different from the first synthesis condition on the basis of the analysis value in response to a determination that the analysis value is larger than the threshold error value; and re-performing, by the main computer, synthesis of the target material on the basis of the second synthesis condition.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept.

In the drawings:

FIG. 1 is a block diagram schematically illustrating a modular experiment automation system according to an embodiment of the inventive concept;

FIG. 2 is a block diagram specifically illustrating a modular experiment automation system according to FIG. 1;

FIG. 3 is a perspective view illustrating a material synthesis module;

FIG. 4 is a perspective view illustrating a reaction vessel storage device of a material synthesis module;

FIG. 5A is an exploded perspective view illustrating a reaction vessel storage device of a material synthesis module;

FIG. 5B is a side view illustrating a reaction vessel storage device of a material synthesis module;

FIG. 6 is a perspective view illustrating an XYZ linear actuator of a material synthesis module;

FIG. 7 is a perspective view illustrating a movement region of an XYZ linear actuator of a material synthesis module;

FIG. 8A is a perspective view illustrating a portion of a specimen injection device of a material synthesis module;

FIG. 8B is a perspective view illustrating a portion of a specimen injection device of a material synthesis module;

FIG. 9 is a transparent perspective view illustrating a coupling part of a material synthesis module;

FIG. 10 is a perspective view illustrating an agitator of a material synthesis module;

FIG. 11 is a perspective view illustrating a material synthesis module;

FIG. 12 is a perspective view illustrating a reaction vessel holder of a material analysis module;

FIG. 13 is a perspective view illustrating a measurement vessel storage of a material analysis module;

FIG. 14 is a perspective view illustrating a measurement vessel holder of a material analysis module;

FIG. 15 is a perspective view illustrating a UV spectrometer of a material analysis module;

FIG. 16 is a flowchart illustrating an operation method of a modular experiment automation system;

FIG. 17 is a graph showing reproducibility of material analysis according to operation of a modular experiment automation system;

FIG. 18 is a graph showing reproducibility of material synthesis according to operation of a modular experiment automation system; and

FIG. 19 is a graph showing errors compared to a target according to the number of experiments when a modular experiment automation system is used.

### DETAILED DESCRIPTION

Hereinafter, embodiments of the inventive concept will be described with reference to the accompanying drawings so that the configuration and effects of the inventive concept are sufficiently understood. However, the inventive concept is not limited to the embodiments described below, but may be implemented in various forms and may allow various modifications. Rather, these embodiments are provided so that this disclosure will be thorough and complete, and will fully convey the scope of the inventive concept to those skilled in the art. In the accompanying drawings, the dimensions of elements are magnified for convenience, and the scale ratios among the elements may be exaggerated or reduced.

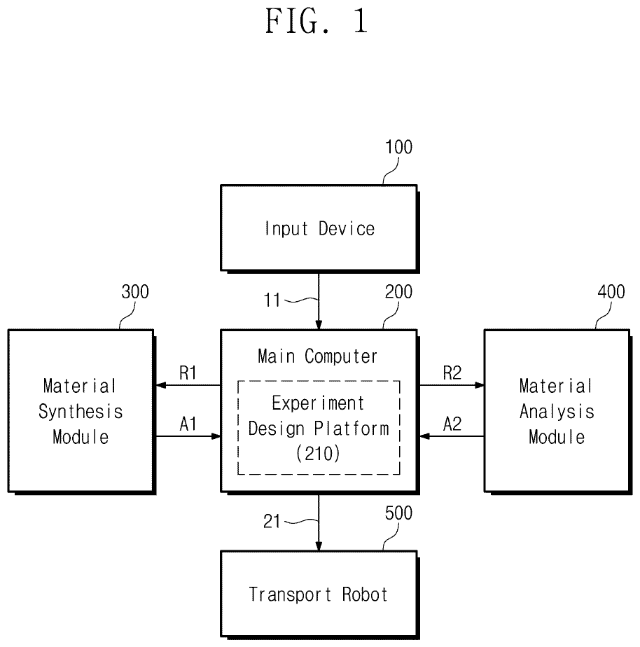

FIG. 1 is a block diagram schematically illustrating a modular experiment automation system according to an embodiment of the inventive concept.

Referring to FIG. 1, a modular experiment automation system 1000 according to an embodiment of the inventive concept may include an input device 100, a main computer 200, a material synthesis module 300, a material analysis module 400, and a transport robot 500.

The input device 100 may transmit a start request 11 to the main computer 200. The start request 11 may be for starting synthesis of a target material. The target material may have a target property. For example, the start request 11 may be for synthesizing Ag nanoparticles having an ultra violet (UV) wavelength of about 600 nm. The input device 100 may communicate with the main computer 200. The input device 100 may be implemented with a display device, a touch screen, a mouse, a keyboard, and the like.

The main computer 200 may be configured to receive the start request from the input device 100. For example, the main computer 200 may be implemented with a personal computer (PC), a laptop computer, a tablet PC, a smartphone, a server device, and the like.

The main computer 200 may include an artificial intelligence (AI)-based experiment design platform 210. The main computer 200 may use the experiment design platform 210 to provide the material synthesis module 300 with a first request R1 for a target material synthesis operation, provide the transport robot 500 with a request 21 for a transport operation so as to transport the synthesized material to an analysis module, and provide the material analysis module 400 with a second request R2 for an operation of measuring a property of the synthesized material. The main computer 200 may receive measurement data of the property of a synthesized material from the material analysis module 400, determine an optimum synthesis condition on the basis of the measurement data, and provide the material synthesis module 300 with a request (i.e., subsequent first request according to an optimized condition) according to the optimum synthesis condition.

In detail, the main computer 200 may receive the start request 11 from the input device 100. The main computer 200 may use the experiment design platform 210 to generate the first request R1 on the basis of the start request 11. The first request R1 may include a first synthesis condition for the target material. The main computer 200 may provide the first request R1 to the material synthesis module 300.

Thereafter, the main computer 200 may receive, from the material synthesis module 300, a first response A1 indicating that a synthesis operation has been performed. The main computer 200 may use the experiment design platform 210 to generate the second request R2 on the basis of the first response A1. The second request R2 may include a synthesized material analysis request. The main computer 200 may provide the second request R2 to the material analysis module 400.

Thereafter, the main computer 200 may receive, from the material analysis module 400, a second response A2 including an analysis value of an analysis operation.

The main computer 200 may determine whether the analysis value is larger than a threshold error value. The threshold error value may correspond to the target property of the target material and may provide a criterion of whether to change a synthesis condition. When the analysis value is larger than the threshold error value, the main computer 200 may generate a second synthesis condition different from the first synthesis condition on the basis of the analysis value. The main computer 200 may re-synthesize the target material on the basis of the second synthesis condition. On the contrary, when the analysis value is equal to or less than the threshold error value, the main computer 200 may end the analysis operation for the target material without performing an additional operation of synthesizing the target material.

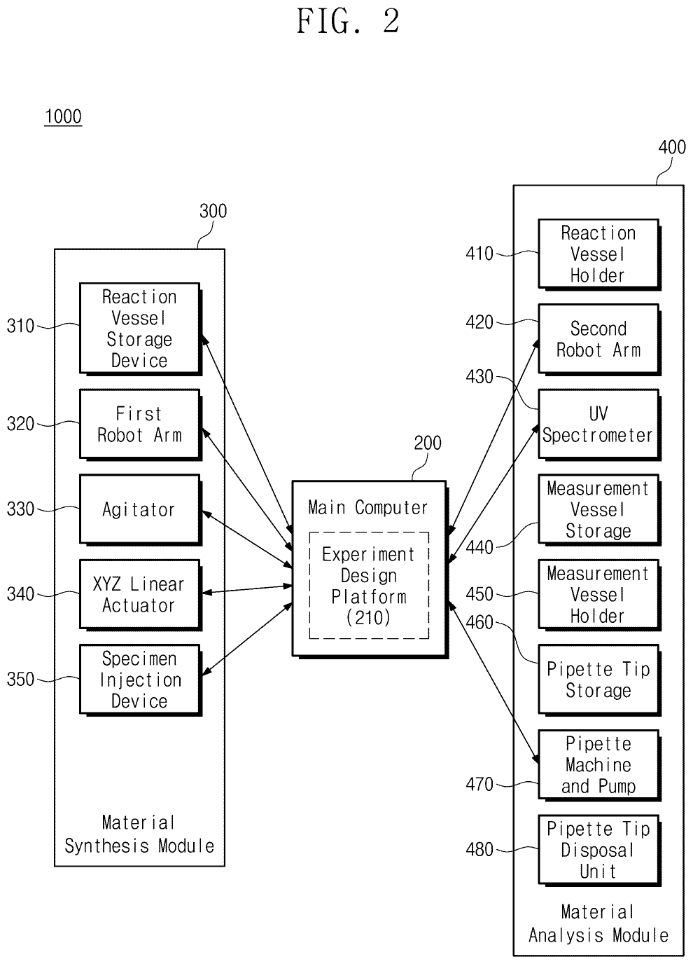

FIG. 2 is a block diagram specifically illustrating a modular experiment automation system according to FIG. 1. In order to clearly illustrate an embodiment of the inventive concept, the input device 100 and the transport robot 500 of FIG. 1 are omitted in FIG. 2. The bidirectional arrows between subcomponents of the main computer 200 and the material synthesis module 300 illustrated in FIG. 2 may include the first request R1 and the first response A1 of FIG. 1. The bidirectional arrows between subcomponents of the main computer 200 and the material analysis module 400 may include the second request R2 and the second response A2 of FIG. 1.

Referring to FIGS. 1 and 2, the material synthesis module 300 may include a reaction vessel storage device 310, a first robot arm 320, an agitator 330, an XYZ linear actuator 340, and a specimen injection device 350.

The reaction vessel storage device 310, the first robot arm 320, the agitator 330, the XYZ linear actuator 340, and the specimen injection device 350 each may receive the first request R1 from the main computer 200 and may perform at least one synthesis operation. When synthesis operations are completed, the reaction vessel storage device 310, the first robot arm 320, the agitator 330, the XYZ linear actuator 340, and the specimen injection device 350 each may transmit the first response A1 indicating the completion of the synthesis operation to the main computer 200.

For example, the reaction vessel storage device 310 may receive the first request R1 from the main computer 200 and may perform an operation of selecting a reaction vessel in which reaction is to be performed. Thereafter, when the operation of selecting a reaction vessel is completed, the reaction vessel storage device 310 may transmit the first response A1 indicating the completion of the operation to the main computer 200.

For example, the first robot arm 320 may receive the first request R1 from the main computer 200 and may perform an operation of moving the selected reaction vessel onto the agitator 330. Thereafter, when the operation of moving a reaction vessel is completed, the first robot arm 320 may transmit the first response A1 indicating the completion of the operation to the main computer 200.

For example, the XYZ linear actuator 340 may receive the first request R1 from the main computer 200 and may perform an operation of moving a specimen injection part of the specimen injection device 350 to the reaction vessel on the agitator 330. Thereafter, when the operation of moving a specimen injection part is completed, the XYZ linear actuator 340 may transmit the first response A1 indicating the completion of the operation to the main computer 200.

For example, the specimen injection device 350 may include a specimen storage and a syringe pump connected to the specimen injection part, and may receive the first request R1 from the main computer 200 to perform an operation of discharging a specimen from the specimen storage to the outside of the specimen injection part using the syringe pump. Thereafter, when the operation of discharging a specimen is completed, the specimen injection device 350 may transmit the first response A1 indicating the completion of the operation to the main computer 200. For example, the agitator 330 may receive the first request R1 from the main computer 200 and may perform an operation of controlling a heating rate and agitating speed of the reaction vessel filled with the specimen. Thereafter, when the operation of controlling a heating rate and agitating speed is completed, the agitator 330 may transmit the first response A1 indicating the completion of the operation to the main computer 200. According to some embodiments, the agitator 330 may additionally receive the first request R1 from the main computer 200, may perform an operation of waiting until the reaction of the specimen is completed in the reaction vessel, and may transmit the first response A1 indicating the completion of the operation.

For example, the transport robot 500 of FIG. 1 may receive, from the main computer 200, the request 21 for transporting the reaction vessel containing a reaction-completed product solution to the material analysis module 400, and may perform a transport operation. For example, the transported reaction vessel may be placed in a reaction vessel holder 410 of the material analysis module 400. Thereafter, when the transport operation is completed, the transport robot 500 may transmit a response indicating the completion of the operation to the main computer 200.

The material analysis module 400 may include the reaction vessel holder 410, a second robot arm 420, a UV spectrometer 430, a measurement vessel storage 440, a measurement vessel holder 450, a pipette tip storage 460, a pipette machine and pump 470, and a pipette tip disposal unit 480.

The second robot arm 420, the UV spectrometer 430, and the pipette machine and pump 470 each may receive the second request R2 from the main computer 200 and may perform at least one analysis operation. When analysis operations are completed, the second robot arm 420, the UV spectrometer 430, and the pipette machine and pump 470 may transmit the second response A2 indicating the completion of the analysis operation to the main computer 200.

For example, the second robot arm 420 may receive the second request R2 from the main computer 200 and may perform an operation of moving a measurement vessel of the measurement vessel storage 440 to a UV holder of the UV spectrometer 430 or the measurement vessel holder 450. Thereafter, when the operation of moving a measurement vessel is completed, the second robot arm 420 may transmit the second response A2 indicating the completion of the operation to the main computer 200.

For example, the UV spectrometer 430 may receive the second request R2 from the main computer 200 and may perform an operation of outputting a reference peak of the measurement vessel in the UV holder. Thereafter, when the operation of outputting a reference peak of the measurement vessel is completed, the UV spectrometer 430 may transmit the second response A2 indicating the completion of the operation to the main computer 200.

For example, the second robot arm 420 and the pipette machine and pump 470 each may receive the second request R2 from the main computer 200, may select a pipette tip in the pipette tip storage 460, and may perform an operation of suctioning the product solution in the reaction vessel by a pipette and an operation of injecting the suctioned solution into the measurement vessel in the UV holder or the measurement vessel holder 450. When the solution injection is completed, the second robot arm 420 and the pipette machine and pump 470 may transmit the second response A2 indicating the completion of this operation to the main computer 200.

According to some embodiments, the second robot arm 420 may receive the second request R2 from the main computer 200 and may perform an operation of moving and dropping a used pipette tip into the pipette tip disposal unit.

For example, the UV spectrometer 430 may receive the second request R2 from the main computer 200 and may perform an operation of outputting an absorbance peak of the solution in the measurement vessel in the UV holder. Thereafter, when the operation of outputting an absorbance peak of the solution is completed, the UV spectrometer 430 may transmit the second response A2 indicating the completion of the operation to the main computer 200.

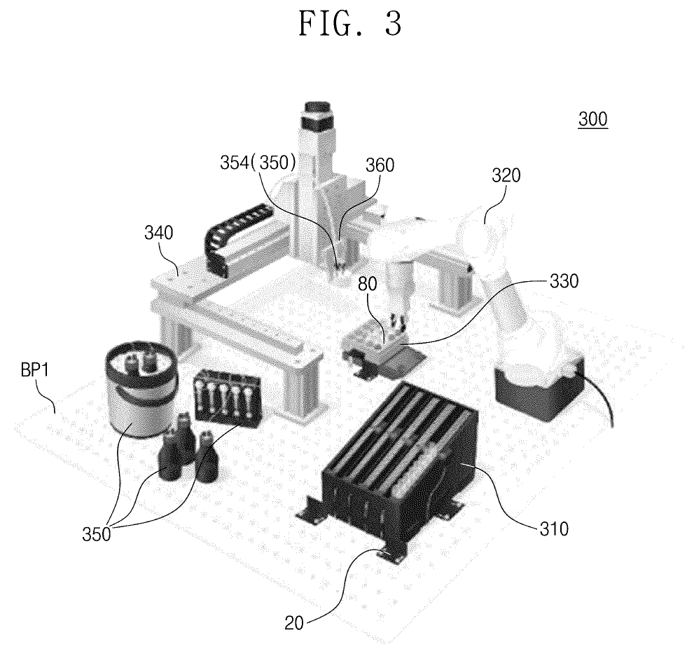

FIG. 3 is a perspective view illustrating a material synthesis module. Referring to FIG. 3, the material synthesis module 300 may be arranged on a first base plate BP1.

For example, the first base plate BP1 may be an aluminum plate. The first base plate BP1 may include perforations arranged at a pitch of dozens of millimeters (mm). For example, the perforations may have a diameter of about 6 mm, and the pitch may be about 50 mm. The diameter and pitch of the perforations may be standardized. Subcomponents of the material synthesis module 300 may be fixed to the first base plate BP1 through a fixing part such as a bolt and fixing bracket 20. Since the first base plate BP1 is standardized, the subcomponents of the material synthesis module 300 fixed thereto may be fixed at a certain position. As a result, the first robot arm 320 may operate at a fixed position, thus improving precision of operation of the first robot arm 320. Although not illustrated, the first base plate BP1 may be provided in plurality according to some embodiments. In this case, a connection part for connecting adjacent first base plates BP1 may be provided.

The reaction vessel storage device 310 may be arranged on one side of the first robot arm 320, and the agitator 330 may be arranged on another side. The reaction vessel storage device 310 and the agitator 330 may be arranged within a movable range of the first robot arm 320. The XYZ linear actuator 340 may be arranged surrounding the agitator 330. The XYZ linear actuator 340 may be spaced apart from the first robot arm 320 with the agitator 330 therebetween. The specimen injection device 350 may be arranged on one side of the XYZ linear actuator 340. The XYZ linear actuator 340 may be coupled to a specimen injection part 354 of the specimen injection device 350 through a coupling part 360. A reaction vessel 80 may be arranged on the agitator 330.

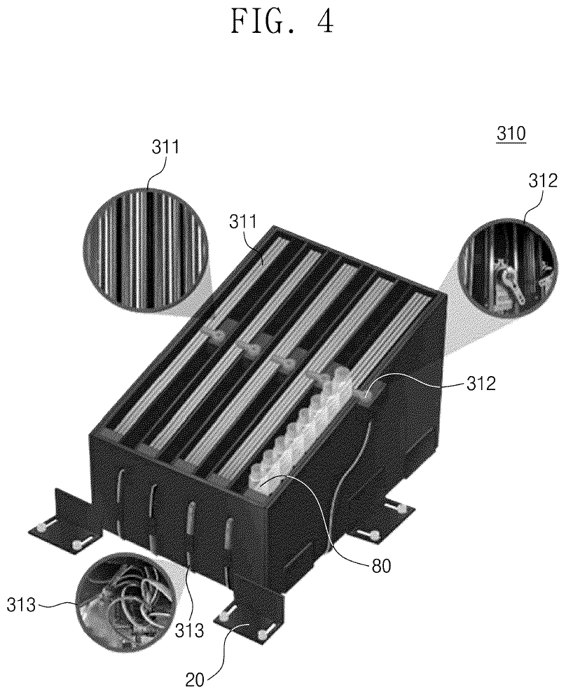

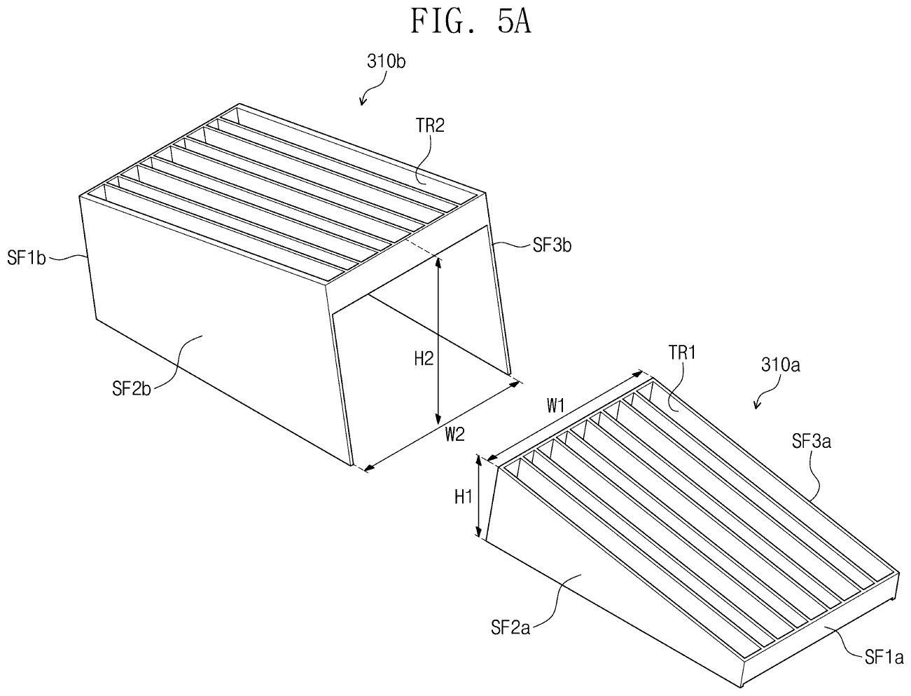

FIG. 4 is a perspective view illustrating a reaction vessel storage device of a material synthesis module. FIG. 5A is an exploded perspective view illustrating a reaction vessel storage device of a material synthesis module. FIG. 5B is a side view illustrating a reaction vessel storage device of a material synthesis module.

Referring to FIGS. 4, 5A, and 5B, the reaction vessel storage device 310 may be fixed to the first base plate BP1 by the fixing bracket 20 or the like.

The reaction vessel storage device 310 may include a first structure 310a and a second structure 310b. The second structure 310b may be arranged on the first structure 310a. The reaction vessel 80 unused may be arranged in the first structure 310a before an experiment, and the reaction vessel 80 used may be arranged in the second structure 310b after an experiment. As illustrated in FIG. 5B, the reaction vessel 80 unused may be empty before an experiment, and the reaction vessel 80 used may be filled with a solution L after an experiment.

As illustrated in FIGS. 5A and 5B, the first structure 310a may have a rectangular first side surface SF1a and a trapezoidal second side surface SF2a and third side surface SF3a that are connected to the first side surface SF1a and have an inclined upper side. A height of each of the second side surface SF2a and the third side surface SF3a may increase in a direction away from the first side surface SF1a.

The second structure 310b may have a shape similar to that of the first structure 310a. The second structure 310b may have a rectangular fourth side surface SF1b and a trapezoidal fifth side surface SF2b and sixth side surface SF3b that are connected to the fourth side surface SF1b and have an inclined upper side. A height of each of the fifth side surface SF2b and the sixth side surface SF3b may increase in a direction away from the fourth side surface SF1b.

The first structure 310a may have a first maximum height H1, and the second structure 310b may have a second maximum height H2. The second maximum height H2 may be larger than the first maximum height H1. The first structure 310a may have a first horizontal width W1, and the second structure 310b may have a second horizontal width W2. The second horizontal width W2 may be larger than the first horizontal width W1. That is, the second structure 310b may cover the first structure 310a.

The first structure 310a and the second structure 310b may respectively include a first space and a second space to accommodate the reaction vessel 80. The first space and the second space each respectively include a plurality of first trenches TR1 and a plurality of second trenches TR2. A depth of the first trench TR1 and a depth of the second trench TR2 may be less than a height of the reaction vessel 80. The first trenches TR1 and the second trenches TR2 may be respectively arranged on the first structure 310a and the second structure 310b. A bottom surface of each of the first trench TR1 and the second trench TR2 may have an inclined surface. A force to slide to the first side surface SF1a may act on the reaction vessel 80 of the first structure 310a along the inclined surface, and a force to slide to the fourth side surface SF1b may act on the reaction vessel 80 of the second structure 310b along the inclined surface.

As illustrated in FIG. 4, a friction reinforcement member 311 may be arranged on the bottom surface of the trench TR. The friction reinforcement member 311 may include a material that increases frictional force when the bottom surfaces of the trenches TR1 and TR2 are slippery, and may include a material that decreases frictional force when the bottom surfaces of the trenches TR1 and TR2 are rough. The friction reinforcement member 311 may include, for example, a stainless steel material.

The reaction vessel storage device 310 may include motor driven region partitioning parts 312. The motor driven region partitioning parts 312 may include a plurality of first motor driven region partitioning parts 312a and a plurality of second motor driven region partitioning parts 312b.

The first structure 310a and the second structure 310b may be respectively coupled to the first motor driven region partitioning part 312a and the second motor driven region partitioning part 312b arranged on sidewalls of the trenches TR1 and TR2. For example, as illustrated in FIG. 5B, the first motor driven region partitioning part 312a may be arranged adjacent to the first side surface SF1a. A distance between the first side surface SF1a and the first motor driven region partitioning part 312a may correspond to a diameter of the reaction vessel 80. That is, the first motor driven region partitioning part 312a may set a section in which only one reaction vessel 80 may be separately arranged. When the first motor driven region partitioning part 312a operates, one reaction vessel 80 may move towards the first side surface SF1a along the inclined surface of the first trench TR1. The first structure 310a may protrude from the second structure 310b in a direction away from the fourth surface SF1b.

For example, as illustrated in FIG. 5B, the second motor driven region partitioning part 312b may be arranged adjacent to the fourth side surface SF1b. A distance between the fourth side surface SF1b and the second motor driven region partitioning part 312b and may correspond to a sum of diameters of the plurality of the reaction vessels 80. That is, the second motor driven region partitioning part 312b may set a section in which the plurality of the reaction vessels 80 may be separately arranged. When the second motor driven region partitioning part 312b operates, one or more reaction vessels 80 may move towards the fourth side surface SF1b along the inclined surface of the second trench TR2.

According to the inventive concept, the reaction vessel storage device 310 may include the first structure 310a and the second structure 310b which vertically overlap each other and have an upper surface at least partially exposed. Furthermore, the first motor driven region partitioning part 312a may set sections in the first structure 310a, and the second motor driven region partitioning part 312b may set sections in the second structure 310b. As a result, the first robot arm 320 may select and move the reaction vessel 80 positioned in a set section in the first structure 310a or the reaction vessel 80 positioned in a set section in the second structure 310b in the reaction vessel storage device 310 that is one integrated space.

As illustrated in FIG. 4, the reaction vessel storage device 310 may include, at a lower portion thereof, a circuit board 313 equipped with an Arduino board for controlling the motor driven region partitioning parts 312.

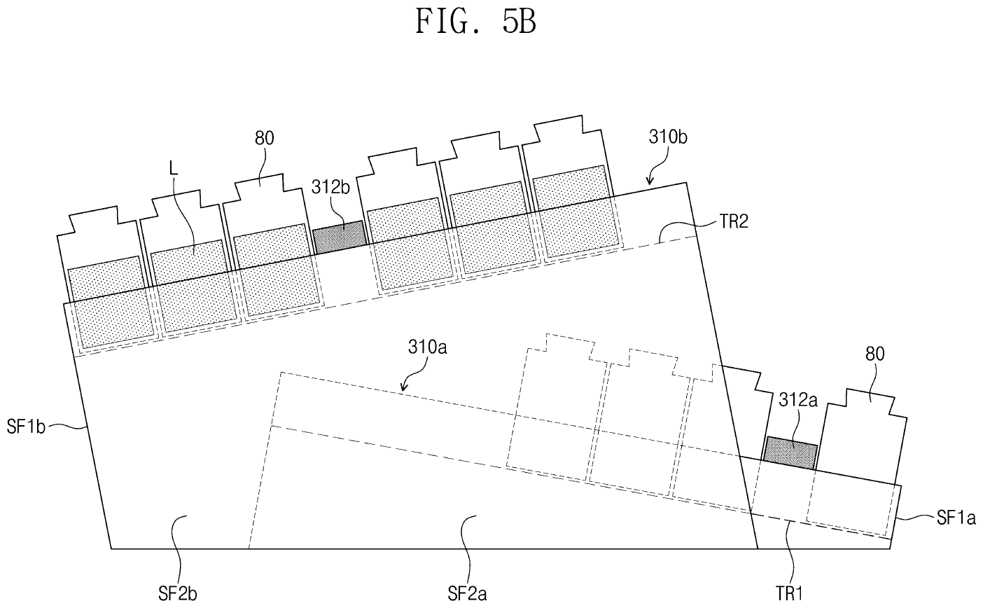

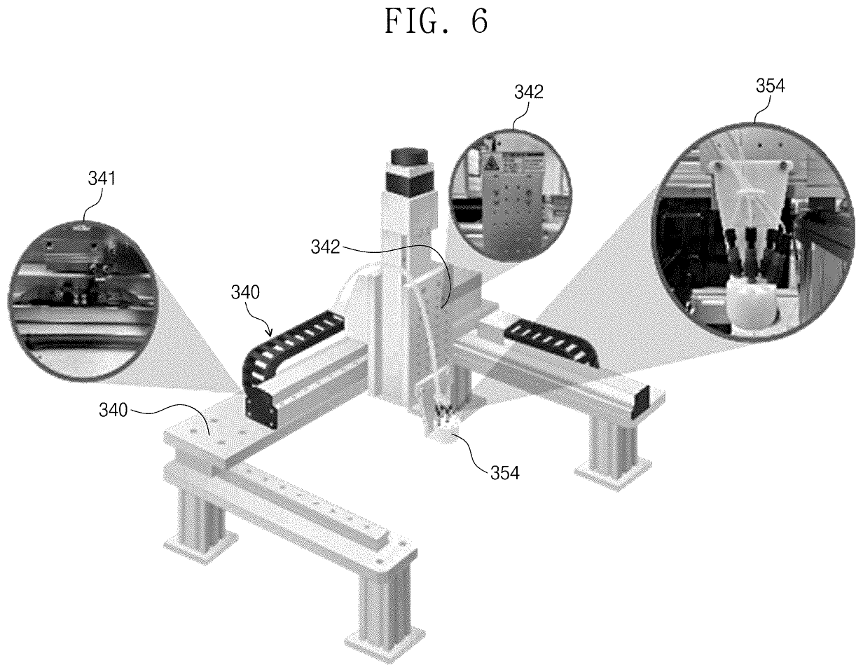

FIG. 6 is a perspective view illustrating an XYZ linear actuator of a material synthesis module. FIG. 7 is a perspective view illustrating a movement region of an XYZ linear actuator of a material synthesis module.

Referring to FIGS. 6 and 7, the XYZ linear actuator 340 may be referred to as a multi-degree-of-freedom robot system or XYZ motor driven system. The XYZ linear actuator 340 may be coupled to the specimen injection part 354 of the specimen injection device 350. The specimen injection part 354 may be fixed to the XYZ linear actuator 340 through a perforated tab 342 and the coupling part 360. The perforated tab 342 may be flexibly attach or detach other experiment devices in addition to the specimen injection part 354.

The XYZ linear actuator 340 may move the specimen injection part 354 in directions along X-axis, Y-axis, and Z-axis. The specimen injection part 354 may move within a first region 340R of FIG. 7 through the XYZ linear actuator 340.

As illustrated in FIG. 6, the XYZ linear actuator 340 may include an infrared sensor 341. The XYZ linear actuator 340 may align a movement start point with the same point using the infrared sensor 341.

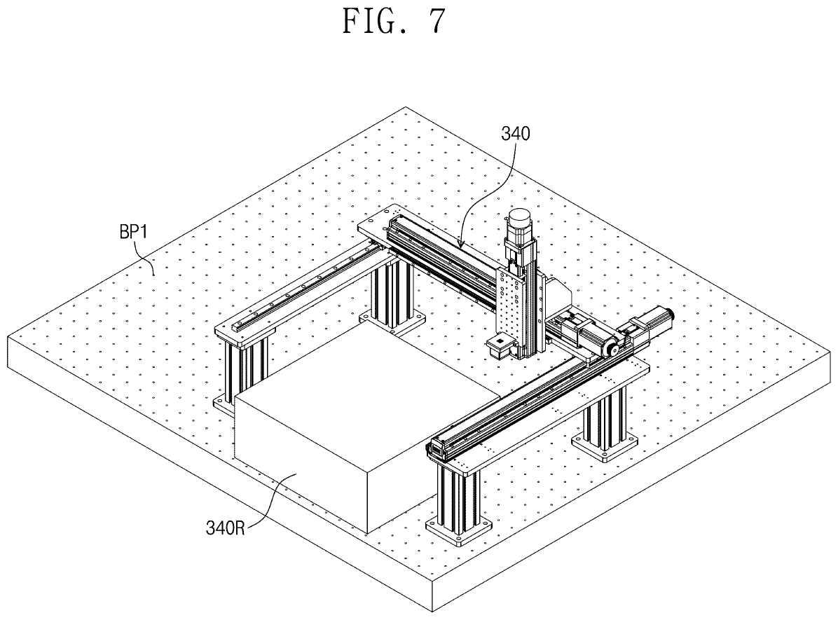

FIG. 8A is a perspective view illustrating a portion of a specimen injection device of a material synthesis module. FIG. 8B is a perspective view illustrating a portion of a specimen injection device of a material synthesis module.

Referring to FIGS. 8A and 8B, the specimen injection device 350 may include a specimen cooling device 351, a specimen storage 352, a syringe pump 353, and the specimen injection part 354. As illustrated in FIG. 8A, the specimen cooling device 351 may serve to decrease a temperature of a solution in the reaction vessel 80 so as to prevent oxidizing power and reducing power of the solution from decreasing.

The specimen cooling device 351 may be, for example, an ice bucket. The specimen storage 352 may be a vessel which stores a specimen solution and includes a component and/or structure that prevents the specimen solution from being changed due to light. The specimen storage 352 may be connected to the syringe pump 353 through a first tube.

The specimen injection part 354 may include a needle 354a, a second tube 354b, and a needle-tube connection part 354c. The second tube 354b may be an independent tube different from the first tube, and may be connected to the syringe pump 353. The needle-tube connection part 354c may be arranged between and connect the needle 354a and the second tube 354b. The needle-tube connection part 354c may serve to prevent leakage of a specimen solution between the second tube 354b and the needle 354a. An inner diameter of the needle-tube connection part 354c may be variously adjusted according to an amount of a specimen solution to be discharged and a discharge rate.

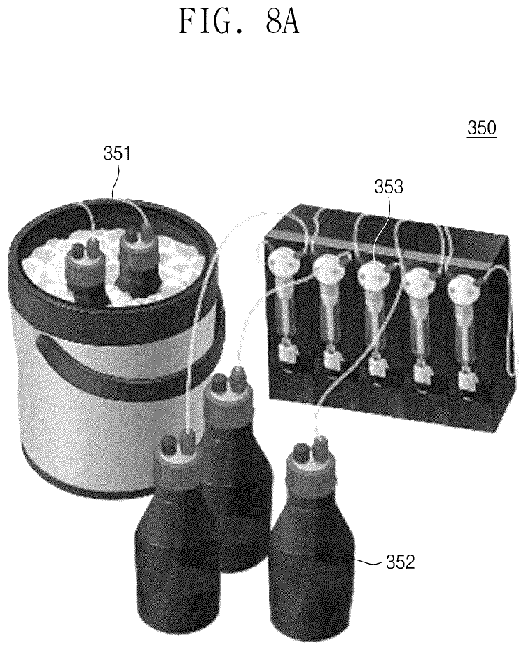

FIG. 9 is a transparent perspective view illustrating a coupling part of a material synthesis module.

Referring to FIG. 9, the coupling part 360 may include a tube holder 361 at an upper portion and a needle arrangement hole 362 at a lower portion. The tube holder 361 may have an annular shape. The needle arrangement hole 362 may be a hole having an upper portion that is larger in diameter than a lower portion.

The tube holder 361 may be configured so that a plurality of second tubes 354b pass through a space in a ring, and may concentrate the second tubes 354b to be close to each other. A plurality of needles 354a may be respectively arranged in the needle arrangement holes 362. Since the needle 354a is fixed through the needle arrangement hole 362, the needle 354a may be accurately positioned on the reaction vessel 40. The needle arrangement hole 362 may have a shape of a hole structure in which a lower hole OP1 and an upper hole OP2 are connected to each other. A diameter of the lower hole OP1 may correspond to a diameter of the needle 354a, and a diameter of the upper hole OP2 may correspond to a width of the needle-tube connection part 354c. The upper holes OP2 are arranged spaced a large distance apart from each other so that a larger number of specimen injection parts 354 may be arranged, and the lower holes OP2 are arranged spaced a small distance apart from each other so that a specimen may be injected to one reaction vessel 80 at the same time or different times. The needle arrangement hole 362 may be in a tilted stated.

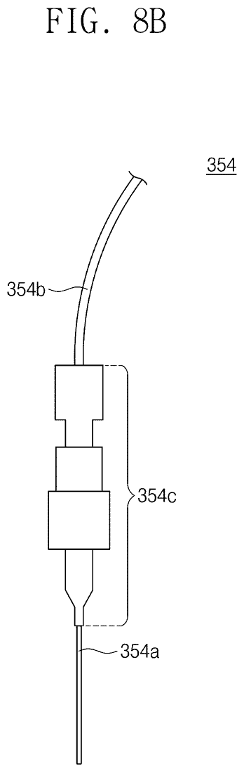

FIG. 10 is a perspective view illustrating an agitator of a material synthesis module.

Referring to FIG. 10, the agitator 330 may be fixed to the first base plate BP1 through a fixing rod 30, the fixing bracket 20, and the like. The agitator 330 may be configured to control a heating temperature, agitating speed, vessel detection, and reaction time. A first reaction vessel holder 331 may be arranged on the agitator 330. In the first reaction vessel holder 331, the reaction vessel 80 not filled with a specimen solution and the reaction vessel 80 filled with the specimen solution L may be arranged. The first reaction vessel holder 331 may be provided in plurality, and a fixing holder 333 may be arranged between the first reaction vessel holders 331 in order to prevent separation during operation of the agitator 330. Higher accuracy may be obtained during a synthesis experiment procedure through the fixing rod 30, the fixing bracket 20, and the fixing holder 333.

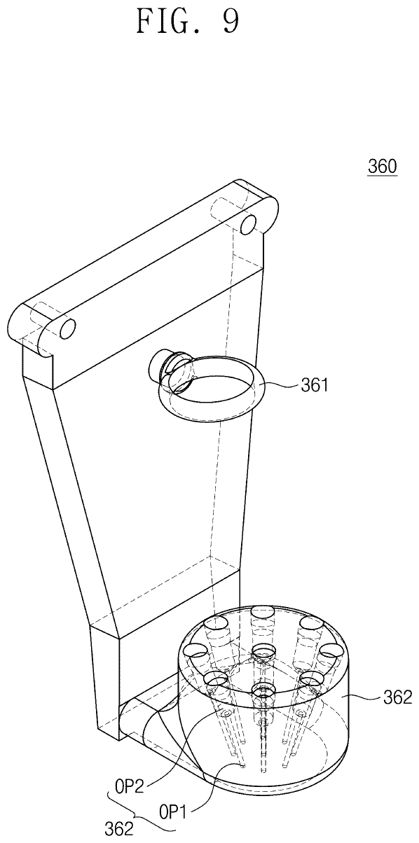

FIG. 11 is a perspective view illustrating a material synthesis module.

Referring to FIG. 11, the reaction vessel holder 410, the second robot arm 420 (not shown), the UV spectrometer 430, the measurement vessel storage 440, the measurement vessel holder 450, the pipette tip storage 460, the pipette machine and pump 470, and the pipette tip disposal unit 480 of the material analysis module 400 may be arranged on a second base plate BP2. The second base plate BP2 may be a substrate extending from the first base plate BP1. Alternatively, the second base plate BP2 may be a separate substrate spaced apart from and independent of the first base plate BP1. The second base plate BP2 may be a plate including perforations having a certain diameter and pitch corresponding to the first base plate BP1. The diameter and pitch of the perforations of the second base plate BP2 may be the same as or different from the diameter and pitch of the perforations of the first base plate BP1. For example, the second base plate BP2 may be an aluminum plate. Although not illustrated, the second base plate BP2 may be provided in plurality according to some embodiments. In this case, a connection part for connecting adjacent second base plates BP2 may be provided.

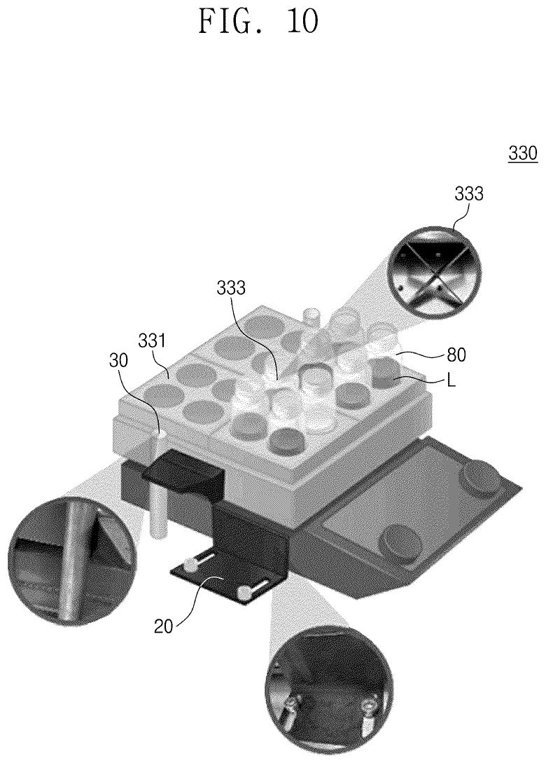

FIG. 12 is a perspective view illustrating a reaction vessel holder of a material analysis module.

Referring to FIGS. 11 and 12, the reaction vessel 80 transported from the transport robot 500 may be arranged in the reaction vessel holder 410. The reaction vessel holder 410 may have a hole having a size corresponding to the diameter of the reaction vessel 80.

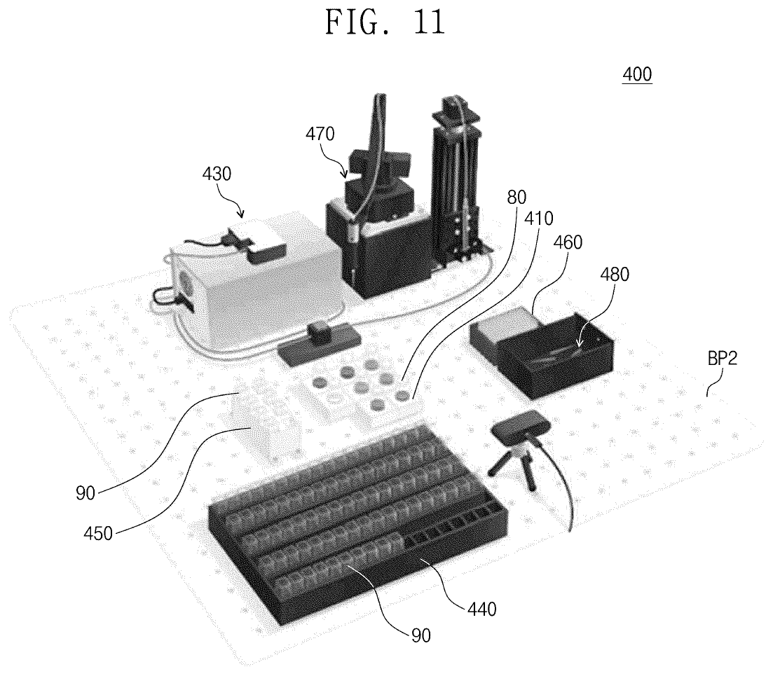

FIG. 13 is a perspective view illustrating a measurement vessel storage of a material analysis module.

Referring to FIGS. 11 and 13, empty measurement vessels 90 may be arranged in the measurement vessel storage 440. The measurement vessel storage 440 may include a plurality of holes. The measurement vessel 90 may be, for example, a cuvette, and a size of the cuvette may be smaller than that of the reaction vessel 80.

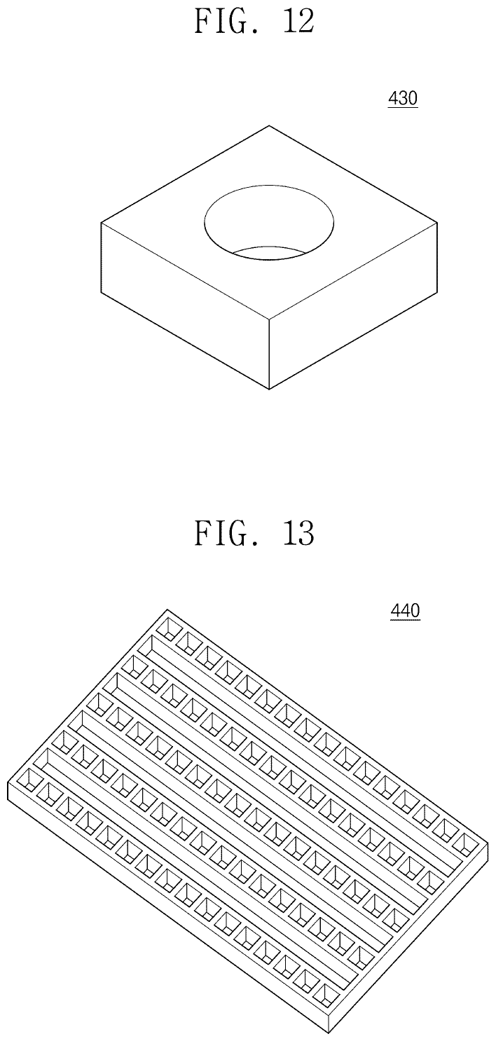

FIG. 14 is a perspective view illustrating a measurement vessel holder of a material analysis module.

Referring to FIGS. 11 and 14, the measurement vessel holder 90 may be a device in which the measurement vessel 90 moved from the measurement vessel storage 440 is positioned before measurement.

The reaction vessel holder 410, the measurement vessel storage 440, and the measurement vessel holder 450 may be devices that have undergone a surface treatment such as fillet. As a result, when the reaction vessel 80 is arranged in the reaction vessel holder 410 and the measurement vessel 90 is arranged in the measurement vessel storage 440 and the measurement vessel holder 450, the reaction vessel 80 and the measurement vessel 90 may be constantly arranged at a fixed position.

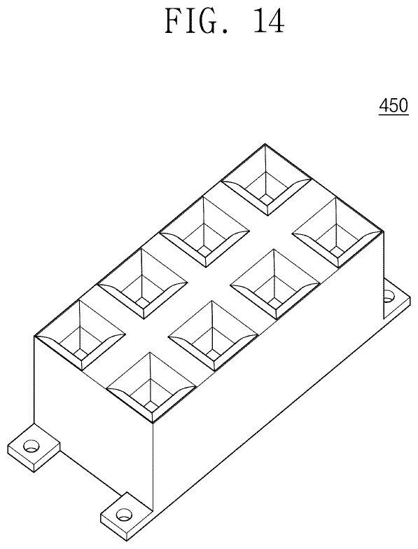

FIG. 15 is a perspective view illustrating a UV spectrometer of a material analysis module.

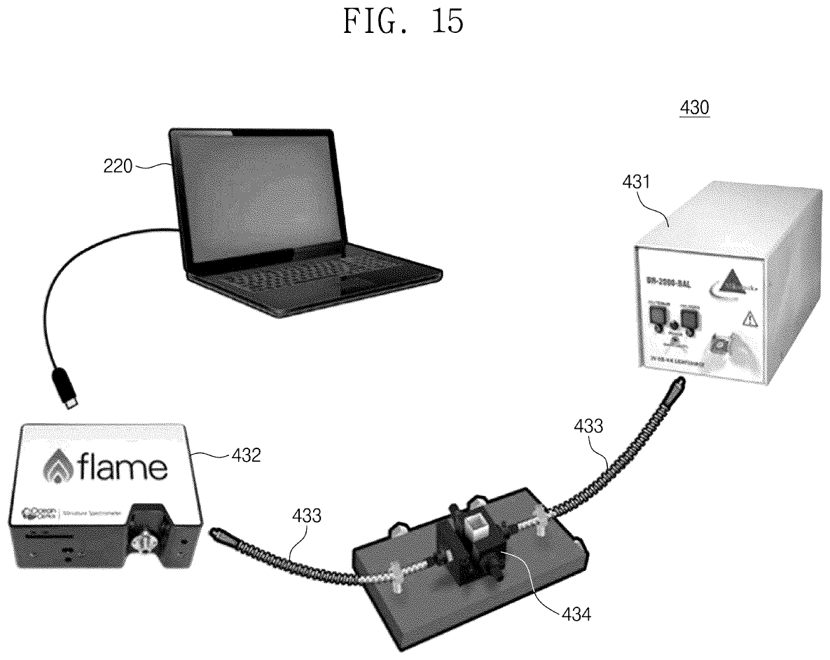

Referring to FIGS. 11 and 15, the UV spectrometer 430 may include a UV light source 431, a UV detector 432, an optical fiber 433, and a UV holder 434. A sub-computer 220 may be provided between the UV spectrometer 430 and the main computer 200 to connect the UV spectrometer 430 to the main computer 200. FIG. 16 is a flowchart illustrating an operation method of a modular experiment automation system.

Referring to FIG. 16, in operation S110, the main computer 200 may receive a start request from the input device 100.

In operation S120, the main computer 200 may provide the material synthesis module with a first request including a first synthesis condition for a target material on the basis of the start request. The material synthesis module may synthesize the target material on the basis of the first request and a specimen.

In operation S121, the material synthesis module may provide the main computer with a first response indicating completion of a synthesis operation.

In operation S130, the main computer, on the basis of the first response, may provide the material analysis module with a second request indicating an analysis operation for the target material.

In operation S131, the material analysis module may analyze the target material, and may provide the main computer with a second response including an analysis value of the analysis operation.

In operation S140, the main computer may determine whether the analysis value is larger than a threshold error value corresponding to a target property of the target material.

In operation S150, in response to a determination that the analysis value is larger than the threshold error value, the main computer may generate a second synthesis condition different from the first synthesis condition on the basis of the analysis value. The second synthesis condition may be generated by an artificial intelligence-based design platform.

In operation S200, the main computer may re-perform synthesis of the target material on the basis of the second synthesis condition.

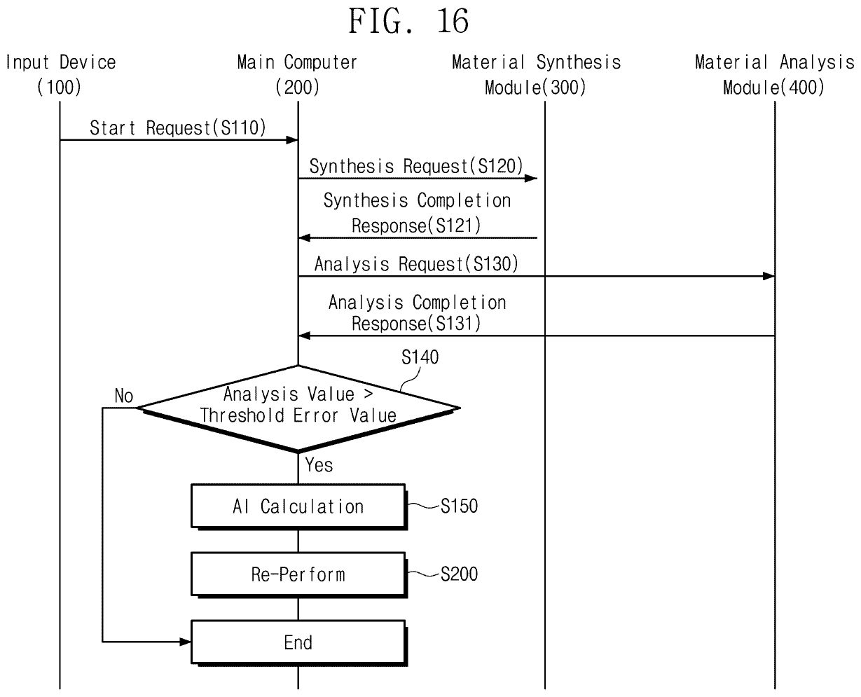

FIG. 17 is a graph showing reproducibility of material analysis according to operation of a modular experiment automation system.

With regard to a single nanoparticle, a maximum absorption wavelength was analyzed 100 times at intervals of 1 second. Referring to FIG. 17, it was determined that the same property is achieved with average λmax=582.9371 nm and standard deviation of ±4.35 nm.

Reliability of a modular experiment automation system is determined on the basis of whether the material analysis module analyzes a single nanoparticle as having the same property. The modular experiment automation system according to an embodiment of the inventive concept improved the reliability of the material analysis module by optimizing fixing devices, robot arms, structures, and arrangement.

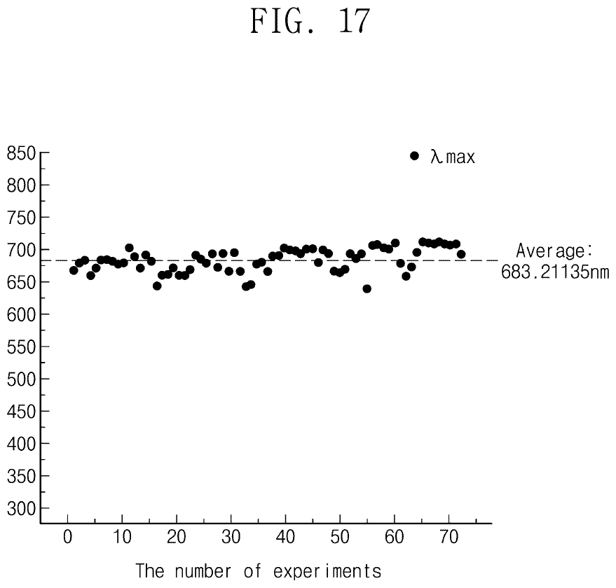

FIG. 18 is a graph showing reproducibility of material synthesis according to operation of a modular experiment automation system.

A silver nanoparticle was generated 100 times under the same condition of AgNO₃ 2000 mL, Citrate 3000 mL, H₂O 100 mL, H₂O₂ 1850 mL, NaBH₄ 3000 μL.

Referring to FIG. 18, it may be understood that a synthesis process has high reproducibility since a standard deviation of ±4.18 is calculated as a result of measuring the maximum absorption wavelength of the silver nanoparticle according to experimental example 1. That is, it may be understood that when the modular experiment automation system according to an embodiment of the inventive concept is operated, nanoparticles having a regular size and shape may be obtained regardless of the number of experiments unlike when experiments are conducted by humans.

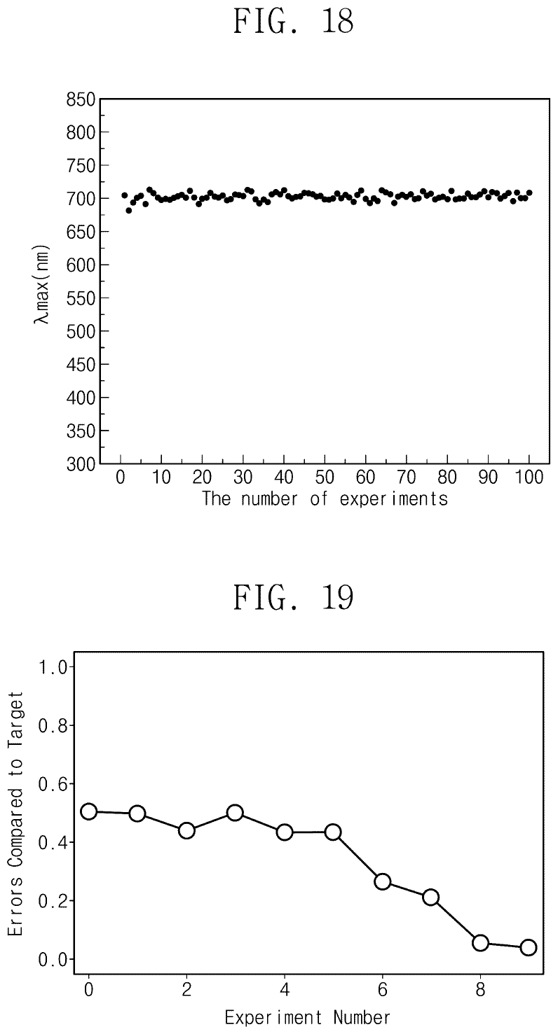

FIG. 19 is a graph showing errors compared to a target according to the number of experiments when a modular experiment automation system is used.

An instruction to synthesize Ag nanoparticles having a wavelength of about 600 nm was input to the input device. The modular experiment automation system predicted and adjusted, for itself, a volume of AgNO₃ that is an optimum precursor for Ag nanoparticle synthesis.

Referring to FIG. 19, Ag nanoparticles for which the analysis value is less than the threshold error value were synthesized after nine experiments. As a result, it may be understood that when a researcher inputs a property of nanoparticles to be developed to the modular experiment automation system according to an embodiment of the inventive concept, the modular experiment automation system predicts an optimum process condition for nanoparticles having the property, and designs, synthesizes, and analyzes the nanoparticles.

The modular experiment automation system according to an embodiment of the inventive concept may include a synthesis module and an analysis module that respond to a request of a main computer. A target material having target characteristics may be synthesized without human intervention by using the modular experiment automation system. Furthermore, the reproducibility of material synthesis and the reproducibility of material analysis may be improved by optimizing the arrangement and structure of subcomponents constituting the modular experiment automation system.

Although the embodiments of the present invention have been described, it is understood that the present invention should not be limited to these embodiments but various changes and modifications can be made by one ordinary skilled in the art within the spirit and scope of the present invention as hereinafter claimed.

### Statement Regarding Prior Disclosures by the Inventor or A Joint Inventor

The inventors of the present application have made related disclosure in “Self-driving laboratory for Bespoke Design of Nanomaterials”, 2022 Fall Conference of the Korean Institute of Metals and Materials, Oct. 27, 2022. The related disclosure was made less than one year before the effective filing date (Jun. 23, 2023) of the present application and the inventors of the present application are the same as those of the related disclosure. Accordingly, the related disclosure is disqualified as prior art under 35 USC 102 (a)(1) against the present application. See 35 USC 102(b)(1)(A).

What is claimed is:

1. A modular experiment automation system comprising:
a main computer configured to receive a start request from an input device;
a material synthesis module configured to synthesize a target material from a specimen; and
a material analysis module configured to analyze the target material,
wherein the main computer is configured to:
provide the material synthesis module with a first request including a first synthesis condition for the target material on the basis of the start request;
receive a first response indicating completion of a synthesis operation from the material synthesis module;
provide the material analysis module with a second request indicating an analysis operation for the target material on the basis of the first response;
receive a second response including an analysis value of the analysis operation from the material analysis module;
determine whether the analysis value is larger than a threshold error value corresponding to a target property of the target material;
generate a second synthesis condition different from the first synthesis condition on the basis of the analysis value in response to a determination that the analysis value is larger than the threshold error value; and
re-perform synthesis of the target material on the basis of the second synthesis condition.

2. The modular experiment automation system of claim 1, wherein the material synthesis module includes at least one of a reaction vessel storage device, a robot arm, an agitator, an XYZ linear actuator, or a specimen injection device.

3. The modular experiment automation system of claim 2,
wherein the reaction vessel storage device includes a first structure and a second structure,
wherein the first structure and the second structure respectively include a first space and a second space to accommodate a reaction vessel.

4. The modular experiment automation system of claim 3, wherein the first structure protrudes from the second structure.

5. The modular experiment automation system of claim 3,
wherein the first space and a second space each include a plurality of trenches,
wherein a bottom surface of each of the trenches has an inclined surface.

6. The modular experiment automation system of claim 5, wherein the first structure and the second structure have a friction reinforcement member arranged on the bottom surface of the trenches.

7. The modular experiment automation system of claim 6, wherein the friction reinforcement member includes a stainless steel material.

8. The modular experiment automation system of claim 6,
wherein the first structure and the second structure each have a rectangular first side surface and a trapezoidal second side surface and third side surface that are connected to the first side surface and have an inclined upper side, and the trench is connected to the first to third side surfaces,
wherein a height of each of the second side surface and the third side surface increases in a direction away from the first side surface.

9. The modular experiment automation system of claim 8,
wherein the first structure includes a motor driven region partitioning part provided on a sidewall of the trench,
wherein the motor driven region partitioning part is arranged adjacent to the first side surface, and
a distance between the first side surface and the motor driven region partitioning part is configured to correspond to a diameter of the reaction vessel.

10. The modular experiment automation system of claim 8,
wherein the second structure includes a motor driven region partitioning part provided on a sidewall of the trench,
wherein a distance between the first side surface and the motor driven region partitioning part is configured to correspond to a sum of diameters of a plurality of reaction vessels.

11. The modular experiment automation system of claim 3, wherein at least one of the first structure or the second structure includes a motor driven region partitioning part provided on a side surface of a trench.

12. The modular experiment automation system of claim 11,
wherein the reaction vessel storage device includes an Arduino board,
wherein the first request includes requesting the Arduino board to perform a control operation on the motor driven region partitioning part.

13. The modular experiment automation system of claim 2,
wherein the specimen injection device is coupled to the XYZ linear actuator, and
the first request includes movement of the XYZ linear actuator.

14. The modular experiment automation system of claim 13,
wherein the specimen injection device includes a specimen storage, a syringe pump, and a specimen injection part,
a specimen of the specimen storage is moved to the specimen injection part through the syringe pump, and
the specimen injection part includes a needle, a tube, and a needle-tube connection part between the needle and the tube.

15. The modular experiment automation system of claim 14, further comprising
a coupling part between the XYZ linear actuator and the specimen injection part,
wherein the coupling part includes a tube holder arranged at an upper portion and a needle arrangement hole arranged at a lower portion,
wherein the needle arrangement hole has a shape of a through-hole having an upper portion that is larger in diameter than a lower portion.

16. The modular experiment automation system of claim 2, wherein the material analysis module includes at least one of a reaction vessel holder, a robot arm, a UV spectrometer, a measurement vessel holder, a pipette machine, or a pipette pump.

17. The modular experiment automation system of claim 2,
wherein the material synthesis module further includes a base plate and a fixing unit,
the reaction vessel storage device, the robot arm, the agitator, the XYZ linear actuator, and the specimen injection device are arranged on the base plate, and
the fixing unit fixes the reaction vessel storage device, the robot arm, the agitator, the XYZ linear actuator, and the specimen injection device to the base plate.

18. The modular experiment automation system of claim 17, wherein the base plate is provided in plurality, the modular experiment automation system further comprising a connection part that connects adjacent base plates.

19. A method of operating a modular experiment automation system comprising a main computer, a material synthesis module, and a material analysis module, the method comprising:
receiving, by the main computer, a start request from an external input device;
providing, by the main computer, the material synthesis module with a first request including a first synthesis condition for a target material having a target property on the basis of the start request;
synthesizing, by the material synthesis module, the target material on the basis of the first request and a raw material;
providing, by the material synthesis module, the main computer with a first response indicating completion of a synthesis operation;
providing, by the main computer, the material analysis module with a second request indicating an analysis operation for the target material on the basis of the first response;
analyzing, by the material analysis module, the target material and providing the main computer with a second response including an analysis value of the analysis operation;
determining, by the main computer, whether the analysis value is larger than a threshold error value corresponding to the target property of the target material;
generating, by the main computer, a second synthesis condition different from the first synthesis condition on the basis of the analysis value in response to a determination that the analysis value is larger than the threshold error value; and
re-performing, by the main computer, synthesis of the target material on the basis of the second synthesis condition.
